(19) United States
(12) Patent Application Publication
(10) Pub. No.: US 2024/0035310 A1
(43) Pub. Date: Feb. 1, 2024

(54) LOW-VOLTAGE ELECTROMECHANICAL STRIKE DEVICE

(71) Applicant: Omar Chibli, Dallas, TX (US)

(72) Inventor: Omar Chibli, Dallas, TX (US)

(21) Appl. No.: 18/362,462

(22) Filed: Jul. 31, 2023

Related U.S. Application Data
(60) Provisional application No. 63/369,852, filed on Jul. 29, 2022.
(60) Provisional application No. 63/516,338, filed on Jul. 28, 2023.

(51) Int. Cl. E05B 47/00

(52) U.S. Cl. CPC E05B 47/0047; E05B 47/0012; E05B 2047/0058; E05B 2047/0054; E05B 2047/0017; E05B 2047/0023; E05B 2047/0036

(57) ABSTRACT

A low-voltage, direct current apparatus for controlling a door, gate, or other access point to a structure or enclosed area. In some embodiments, the apparatus may comprise a housing, a face plate coupled to the housing, a strike plate coupled to the housing, and a keeper disposed between the face plate and the strike plate. The keeper may be rotatably coupled to the housing and may have a cavity configured to receive a latch coupled to a door or other access point. A motor may be disposed within the housing, and a shaft may be coupled to the motor. An actuator arm may be coupled to the shaft. The motor may be operable to rotate the shaft to move the actuator arm from a locked position to prevent movement of the keeper to an unlocked position to allow movement of the keeper.

### TECHNICAL FIELD

The invention set forth in the appended claims relates generally to systems and apparatuses for controlling access to a building, including, without limitation, electromechanical strike devices.

### BACKGROUND

Electronic access control devices, including electromechanical strikes, are in widespread use in commercial buildings and allow access to buildings or other areas to be restricted. For example, a door with an electromechanical strike generally remains locked from the outside, unless activated. If activated, an electromechanical strike can release a latch in a door, thereby unlocking the door. An electromechanical strike can be configured to automatically return to a locked position when a door is closed. A door with an electromechanical strike can additionally be configured to be opened from the inside by pressing a panic bar or other manual release device.

While the benefits of electromechanical strikes are widely known, improvements to such devices can significantly reduce cost of operation, including power and maintenance requirements.

### BRIEF SUMMARY

New and useful systems and apparatuses for controlling access to a building are set forth in the appended claims. Illustrative embodiments are also provided to enable a person skilled in the art to make and use the claimed subject matter.

For example, some embodiments may comprise a low-voltage, direct current apparatus for controlling a door, gate, or other access point to a structure or enclosed area. In some embodiments, the apparatus may comprise a housing, a face plate coupled to the housing, a strike plate coupled to the housing, and a keeper disposed between the face plate and the strike plate. The keeper may be rotatably coupled to the housing and may have a cavity configured to receive a latch coupled to a door or other access point. A motor may be disposed within the housing, and a shaft may be coupled to the motor. An actuator arm may be coupled to the shaft. The motor may be operable to rotate the shaft to move the actuator arm from a locked position in which the actuator arm prevents movement of the keeper to an unlocked position in which the actuator arm allows movement of the keeper. The motor is operable on direct current at twelve volts or less.

In more particular examples, a locking arm may be rotatably coupled to the housing, and the locking arm configured to prevent movement of the keeper in the locked position and to allow movement of the keeper in the unlocked position. In some embodiments, a blocking arm may be rotatably coupled to the housing, and the locking arm can be configured to prevent movement of the blocking arm in the locked position and to allow movement of the blocking arm in the unlocked position. The blocking arm is configured to prevent rotation of the keeper in the locked position.

In yet other examples, some embodiments may comprise a lead screw mounted to the shaft, a nut coupled to the lead screw and to a proximal end of the actuator arm, a locking arm having a first end rotatably coupled to the housing and a second end coupled to the actuator arm, and a blocking arm rotatably coupled to the housing. Rotating the shaft can rotate the lead screw, thereby moving the nut and the actuator arm to move the locking arm. The locking arm can be configured to prevent movement of the blocking arm in the locked position and to allow movement of the blocking arm in the unlocked position, and the blocking arm can be configured to prevent rotation of the keeper in the locked position.

In other examples, some embodiments may comprise a housing and a keeper rotatably coupled to the housing. The keeper may have a cavity configured to receive a latch. A motor may be disposed within the housing, a shaft may be coupled to the motor, an actuator arm may be coupled to the shaft, and a locking arm may be coupled to the actuator arm. The motor can be operated to rotate the shaft, moving the actuator arm from a locked position to an unlocked position. The locking arm can be configured to prevent movement of the keeper in the locked position and can be configured to allow movement of the keeper in the unlocked position. In some embodiments, a blocking arm can be rotatably coupled to the housing. The locking arm can be configured to prevent movement of the blocking arm in the locked position and to allow movement of the blocking arm in the unlocked position. The blocking arm can be configured to prevent rotation of the keeper in the locked position.

In yet other examples, an access control device may comprise a motor and a locking arm coupled to the motor. The motor can be operated on direct current at twelve volts or less to move the locking arm from a locked position to an unlocked position. Some embodiments may additionally comprise a keeper configured to receive a latch, and in the locked position, the locking arm can prevent rotation of the keeper. In the unlocked position, the locking arm allows rotation of the keeper to release the latch.

Additionally, or alternatively, some embodiments may further comprise an access control unit coupled to the motor and configured to determine if access should be allowed. If the access control unit determines that access should be allowed, the access control unit can deliver power to the motor.

Features, elements, and aspects described in the context of some embodiments may also be omitted, combined, or replaced by alternative features. Other features, objectives, advantages, and a preferred mode of making and using the claimed subject matter are described in greater detail below with reference to the accompanying drawings of illustrative embodiments.

### BRIEF DESCRIPTION OF THE DRAWINGS

The accompanying drawings illustrate some objectives, advantages, and a preferred mode of making and using some embodiments of the claimed subject matter. Like reference numbers represent like parts in the examples.

FIG. 1 is a schematic diagram of an example of a system for controlling access to a building.

FIG. 2 is an isometric view of an example of an electromechanical strike that may be associated with some embodiments of the system of FIG. 1.

FIG. 3 (FIG. 3A and FIG. 3B) is a schematic diagram illustrating operation of an example of the strike.

FIG. 4 is schematic diagram of an example of a portion of the strike of FIG. 2 in a locked configuration.

FIG. 5 is a schematic diagram of the strike of FIG. 4 in an unlocked configuration.

FIG. 6 is a schematic diagram of the strike of FIG. 4 with certain components removed to illustrate additional details that may be associated with some embodiments.

FIG. 7 is a schematic diagram of the strike of FIG. 5 with certain components removed to illustrate additional details that may be associated with some embodiments.

FIG. 8 is an assembly view of the lock actuator of FIG. 6, illustrating additional details that may be associated with some embodiments.

### DESCRIPTION OF EXAMPLE EMBODIMENTS

The following description of example embodiments provides information that enables a person skilled in the art to make and use the subject matter set forth in the appended claims, but it may omit certain details already well known in the art. The following detailed description is, therefore, to be taken as illustrative and not limiting.

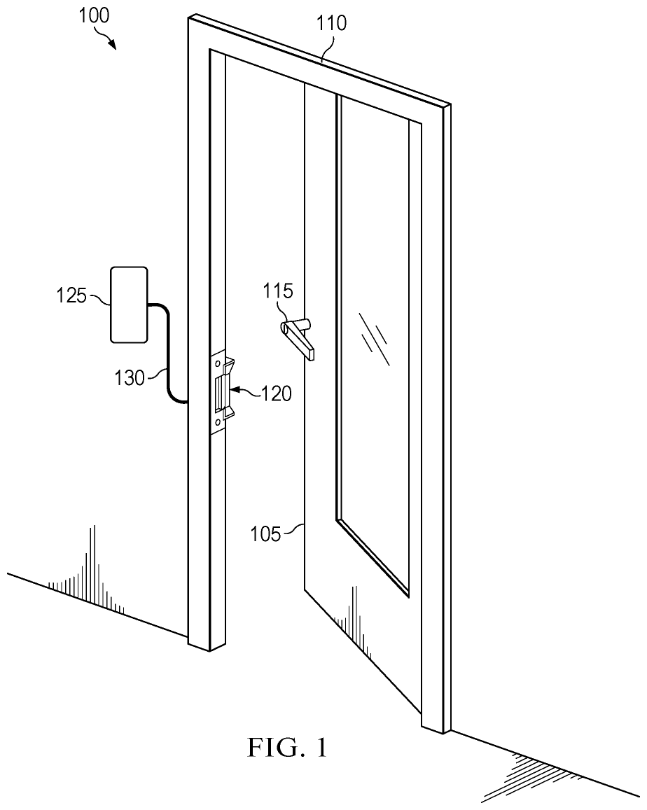

FIG. 1 is a schematic diagram of an example of a system 100 for controlling access to a structure or other area through an access point, such as a door 105. In the example of FIG. 1, the system 100 comprises a door frame 110, and the door 105 is configured to open to the interior of a structure. The system 100 may additionally comprise an exit device 115 and a strike 120. In the example of FIG. 1, the exit device 115 is a mortise latch. In other examples, the exit device 115 may be a push bar or other suitable device. The exit device 115 of FIG. 1 is coupled to the door 105, and the strike 120 is coupled to the door frame 110.

The system 100 may additionally have an access control unit 125 and a conductor 130. In some embodiments, the access control unit 125 may be configured to read or receive a signal from an identification unit (not shown), such as a radio frequency identifier (RFID), a magnetic stripe card, keypad, biometric scanner, or Bluetooth device. The access control unit 125 may be powered by relatively low-voltage, direct current source, such as a battery having a voltage in a range of about three (3) volts to about twelve (12) volts, and preferably less than six (6) volts. The conductor 130 may electrically couple the access control unit 125 to the strike 120.

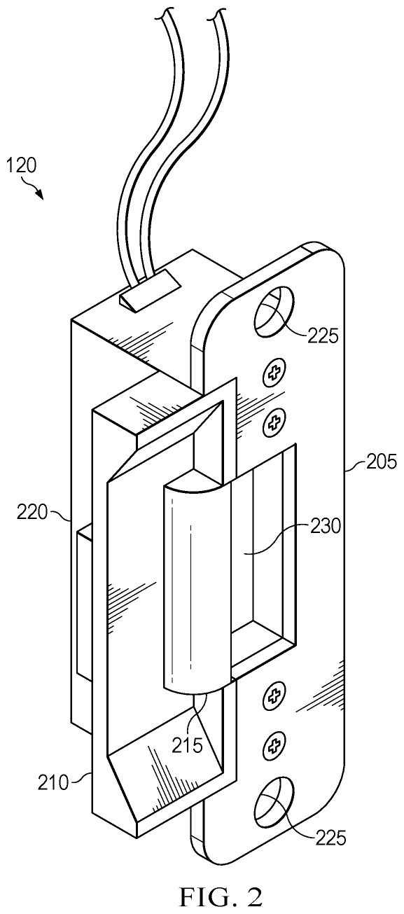

FIG. 2 is an isometric view of an example of the strike 120, illustrating additional details that may be associated with some embodiments. For example, the strike 120 of FIG. 2 generally comprises a face plate 205, a strike plate 210, a keeper 215, and a housing 220. The face plate 205 may have one or more mounting holes 225 in it through which screws can be inserted to fasten the strike 120 to a door frame, such as the door frame 110 of FIG. 1. The strike plate 210 can be coupled to the face plate 205, and the keeper 215 may be disposed between the face plate 205 and the strike plate 210. The strike plate 210 can provide a path for a latch to enter or exit the keeper 215. The strike plate 210 can also bridge a gap between the face plate 205 and the edge of the door frame 110. The face plate 205, the strike plate 210, or both, may be coupled to the housing 220. The keeper 215 may comprise a cavity, notch, step, catch, or similar detent into which a latch can project if a door is closed. For example, the keeper 215 of FIG. 2 comprises a cavity 230, and the exit device 115 of FIG. 1 may have a latch that is configured to project into the cavity 230 if the door 105 is closed. The keeper 215 of FIG. 2 is rotatably coupled to the housing 220. In some embodiments, for example, the keeper 215 may be coupled to a pivot pin (not shown), which can be coupled to the housing 220, and a return spring (not shown) can return the keeper 215 to its original position if rotated. For example, a latch can pivot the keeper 215 outward if the strike 120 is activated, thereby releasing the latch and allowing the door 105 to be opened.

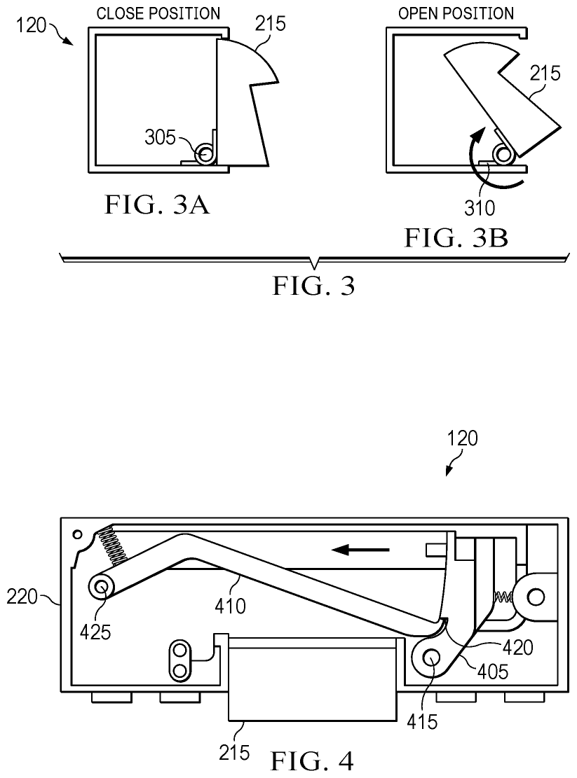

FIG. 3A and FIG. 3B are schematic diagrams illustrating operation of an example of the strike 120. In the example of FIG. 3A, the keeper 215 is coupled to a hinge 305 and in a closed position. For example, if the door 105 is closed so that a latch associated with the exit device 115 is captured in the cavity 230 of the keeper 215, the door 105 cannot be opened from the outside if the latch cannot move the keeper 215. If not locked, the latch can rotate the keeper 215 about the hinge 305, and the door 105 can open. A return spring 310 can return the keeper 215 to its original position after the door 105 is opened.

FIG. 4 is schematic diagram of an example of a portion of the strike 120 of FIG. 2 in a locked configuration, illustrating additional details that may be associated with some embodiment. The face plate 205 and the strike plate 210 of FIG. 2 have been removed in FIG. 4 to illustrate an interior portion of the housing 220. As shown in the example of FIG. 4, the strike 120 may comprise a locking arm 405 and a blocking arm 410.

The locking arm 405 may be rotatably coupled to the housing 220. For example, the locking arm 405 may be coupled to a hinge or pin, such as a pin 415, which may be coupled to the housing 220, as illustrated in the example of FIG. 4. Some embodiments of the locking arm 405 may have a cavity, notch, step, catch, or other similar detent. For example, the locking arm 405 of FIG. 4 has a detent 420, which can latch to the distal end of the blocking arm 410, as illustrated in FIG. 4.

The blocking arm 410 may also be rotatably coupled to the housing 220. For example, the blocking arm 410 may be coupled to a pin 425, which can be coupled to the housing 220, as illustrated in the example of FIG. 4. The blocking arm 410 may include a portion in contact with the keeper 215.

In the locked position of FIG. 4, a distal end of the blocking arm 410 may be in contact or otherwise engaged with the locking arm 405, which can prevent rotation of the blocking arm 410 about the pin 425. In such a position, the locking arm 405 can prevent rotation of the keeper 215. More particularly, in the example of FIG. 4, the locking arm 405 can prevent rotation of the blocking arm 410, which can prevent movement of the keeper 215.

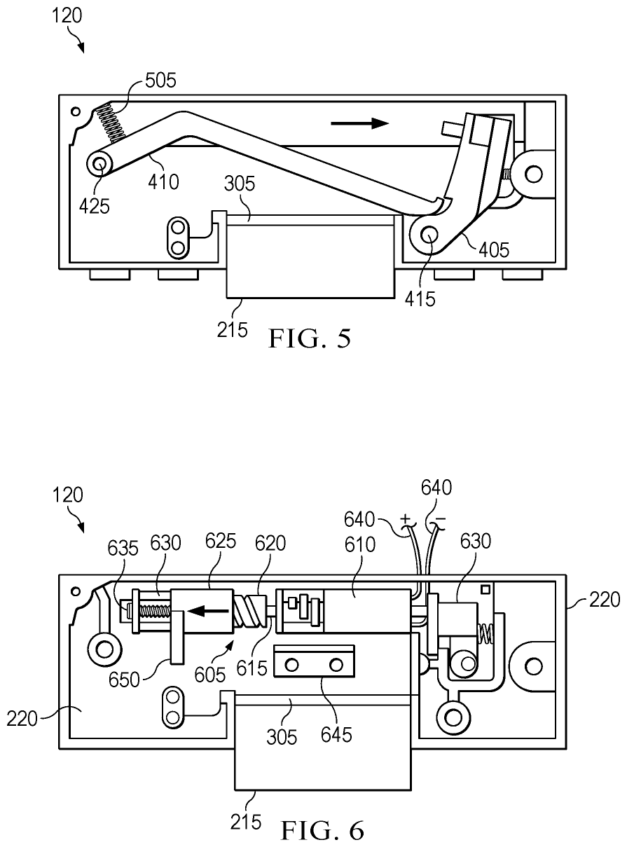

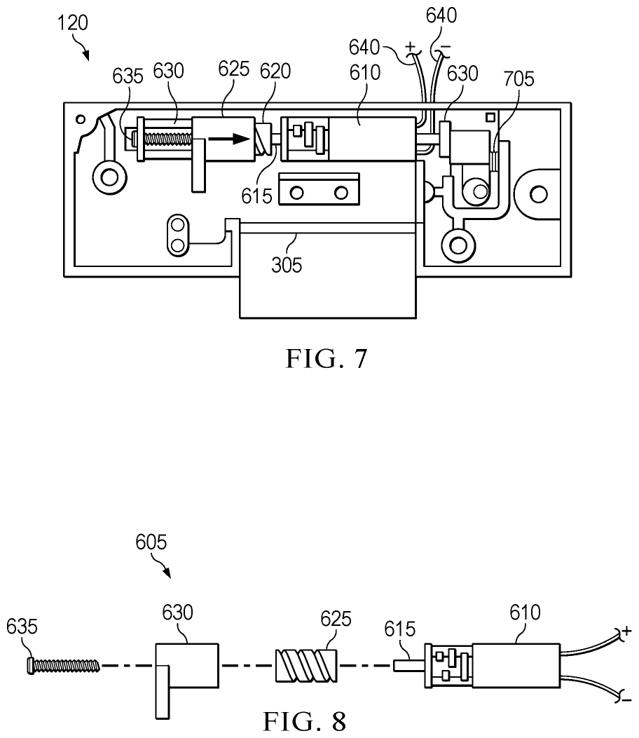

FIG. 5 is a schematic diagram of the strike 120 of FIG. 4 in an unlocked configuration. In this configuration, the locking arm 405 is disengaged from the blocking arm 410. For example, an actuator (such as described in more detail below with reference to FIG. 6 and FIG. 7) can move the locking arm 405 away from the distal end of the blocking arm 410. As illustrated in FIG. 5, some embodiments of the locking arm 405 may rotate about the pin 415 to disengage from the blocking arm 410, which can allow the blocking arm 410 to rotate about the pin 425. If the blocking arm 410 can rotate about the pin 425, the keeper 215 can also rotate about the hinge 305, which can allow a door to be opened. A return spring 505 can return the blocking arm 410 to the original position.

FIG. 6 is a schematic diagram of the strike 120 of FIG. 4 with the blocking arm 410 and other components removed to illustrate additional details that may be associated with some embodiments. For example, FIG. 6 illustrates a lock actuator 605 that may be associated with some embodiments. The lock actuator 605 generally comprises a motor 610 having a shaft 615, a lead screw 620, a nut 625, and an actuator arm 630. The actuator arm 630 may be coupled to the nut 625. For example, a screw 635 can couple the nut 625 to the actuator arm 630 in some embodiments.

The motor 610 may be a direct current motor in some embodiments and can be operated at a range of about three (3) volts to about twelve (12) volts. For example, a micro-gear motor capable of operating at 300 revolutions per minute and three (3) volts may be particularly useful in some embodiments. As shown in the example of FIG. 6, the motor may be disposed within the housing substantially parallel to the hinge 305 of the keeper 215. Conductors 640 may be coupled to the motor 610 and to a source of direct current to provide power to the motor 610. For example, the motor 610 may be coupled to the access control unit 125 of FIG. 1, or more particularly, to the conductor 130 or a battery in the access control unit 125.

The motor 610 may be coupled to the housing 220 in some embodiments to constrain axial and lateral movement. In the example of FIG. 6, the motor 610 is retained in position within the housing 220 by a plate 645, which can be coupled to the housing 220. In other examples, the motor 610 may be coupled to the housing with a screw or other fastener.

The lead screw 620 may be coupled to the shaft 615, and the nut 625 may be threaded onto the lead screw 620. Rotation of the nut 625 can be constrained or prevented by a suitable constraint mechanism. For example, the nut 625 may have flat surfaces that can be retained by the housing 220 or restraining plates coupled to the housing 220. In the example of FIG. 6, a retention arm 650 is coupled to the nut 625, which can be constrained by the housing 220 to prevent rotation of nut 625 while allowing axial movement.

The actuator arm 630 may be coupled to the nut 625 and to the locking arm 405. For example, in some embodiments, a first end of the actuator arm 630 may be coupled to the screw 635, which is coupled to the nut 625, and a second end of the actuator arm 630 may be coupled to the locking arm 405. As shown in the example of FIG. 6, the motor 610 may be mounted over the actuator arm 630 in some embodiments.

FIG. 7 is a schematic diagram of the strike 120 of FIG. 5 with the blocking arm 410 and other components removed to illustrate additional details that may be associated with some embodiments. In operation, the motor 610 can be operated to control the rotation of the shaft 615 to move the actuator arm 630 from a locked position to an unlocked position. For example, the motor 610 of FIG. 7 can move the actuator arm 630 to move the locking arm 405 from the locked position of FIG. 4 to the unlocked position of FIG. 5. In the example of FIG. 7, the motor 610 can rotate the shaft 615 to control the rotation of the lead screw 620, which in turn can control movement of the nut 625 and the actuator arm 630.

For example, if the access control unit 125 determines that access should be allowed, the access control unit 125 can deliver power to the motor 610 through the conductors 640, which can cause the motor 610 to rotate the shaft 615 in a first direction. The rotation of the shaft 615 in this first direction can rotate the lead screw 620 in the first direction. Since the nut 625 is rotationally constrained, rotation of the lead screw 620 can move the nut 625 axially relative to the lead screw 620, which in turn can move the actuator arm 630. In the example of FIG. 7, the movement of the actuator arm 630 is parallel to the axis of the shaft 615 (and the hinge 305). The nut 625, the screw 635, and the actuator arm 630 (beneath the motor 610) of FIG. 7 have been moved from the locked configuration of FIG. 6 to an unlocked configuration, which in turn has rotated the locking arm 405 away from the distal end of the blocking arm 410 (as illustrated in FIG. 5).

If the polarity of the power to the motor 610 is reversed, the motor 610 can rotate the shaft 615 in a second direction, which can rotate the lead screw 620 in a second direction to return the nut 625 and the screw 635. A return spring 705 can return the actuator arm 630 to the locked position of FIG. 6, which in turn also returns the locking arm 405 to a locked position to engage the blocking arm 410.

FIG. 8 is an assembly view of the lock actuator 605 of FIG. 6, illustrating additional details that may be associated with some embodiments.

In general, components of the system 100 may be coupled directly or indirectly. For example, the motor 610 may be directly coupled to the shaft 615 and may be indirectly coupled to the locking arm 405 through the actuator arm 630. Coupling may include fluid, mechanical, thermal, electrical, or chemical coupling (such as a chemical bond), or some combination of coupling in some contexts. For example, the motor 610 may be mechanically coupled to the shaft 325 and may be electrically coupled to the access control unit 125. In some embodiments, components may also be coupled by virtue of physical proximity, being integral to a single structure, or being formed from the same piece of material.

The systems, apparatuses, and methods described herein may provide significant advantages. Some embodiments may be particularly advantageous for reducing the cost of operating and maintaining doorway exit devices. For example, some embodiments can be installed without installing additional power sources or connecting to utility power sources, which can significantly reduce installation cost and allow installation in locations without utility power.

While shown in a few illustrative embodiments, a person having ordinary skill in the art will recognize that the systems, and apparatuses described herein are susceptible to various changes and modifications that fall within the scope of the appended claims. Moreover, descriptions of various alternatives using terms such as “or” do not require mutual exclusivity unless clearly required by the context, and the indefinite articles “a” or “an” do not limit the subject to a single instance unless clearly required by the context. Components may also be combined or eliminated in various configurations for purposes of sale, manufacture, assembly, or use. For example, in some configurations, the lock actuator 605 may be separated from or combined with other components in various ways for sale, manufacture, assembly, or use.

The claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

1. An apparatus for controlling a door, the apparatus comprising:
a housing;
a face plate coupled to the housing;
a strike plate coupled to the housing;
a keeper disposed between the face plate and the strike plate, the keeper rotatably coupled to the housing and having a cavity configured to receive a latch coupled to the door;
a motor disposed within the housing;
a shaft coupled to the motor; and
an actuator arm coupled to the shaft;
wherein the motor is operable to rotate the shaft to move the actuator arm from a locked position in which the actuator arm prevents movement of the keeper to an unlocked position in which the actuator arm allows movement of the keeper.

2. The apparatus of claim 1, further comprising:
a locking arm rotatably coupled to the housing, the locking arm configured to prevent movement of the keeper in the locked position and to allow movement of the keeper in the unlocked position.

3. The apparatus of claim 1, further comprising:
a locking arm rotatably coupled to the housing; and
a blocking arm rotatably coupled to the housing;
wherein the locking arm is configured to prevent movement of the blocking arm in the locked position and to allow movement of the blocking arm in the unlocked position, and the blocking arm is configured to prevent rotation of the keeper in the locked position.

4. The apparatus of claim 1, further comprising:
a lead screw mounted to the shaft;
a nut coupled to the lead screw and to a proximal end of the actuator arm;
a locking arm having a first end rotatably coupled to the housing and a second end coupled to the actuator arm; and
a blocking arm rotatably coupled to the housing;
wherein rotating the shaft rotates the lead screw, thereby moving the nut and the actuator arm to move the locking arm;
wherein the locking arm is configured to prevent movement of the blocking arm in the locked position and to allow movement of the blocking arm in the unlocked position; and
wherein the blocking arm is configured to prevent rotation of the keeper in the locked position.

5. The apparatus of claim 1, further comprising:
a locking arm rotatably coupled to the housing; and
a blocking arm rotatably coupled to the housing;
wherein the locking arm is configured to prevent movement of the blocking arm in the locked position;
wherein the blocking arm is configured to prevent rotation of the keeper in the locked position; and
wherein the actuator arm is configured to rotate the locking arm away from the blocking arm to allow the blocking arm to rotate in the unlocked position.

6. The apparatus of claim 1, wherein:
the keeper is rotatable about a hinge; and
the actuator arm is disposed within the housing substantially parallel to the hinge.

7. The apparatus of claim 1, wherein the motor is operable on direct current at twelve volts or less.

8. The apparatus of claim 1, wherein the motor is operable on direct current in a range of about three volts to about six volts.

9. An apparatus for controlling an access point, the apparatus comprising:
a housing;
a keeper rotatably coupled to the housing and having a cavity configured to receive a latch;
a motor disposed within the housing;
a shaft coupled to the motor;
an actuator arm coupled to the shaft; and
a locking arm coupled to the actuator arm;
wherein the motor is operable to rotate the shaft to move the actuator arm from a locked position to an unlocked position, the locking arm prevents movement of the keeper in the locked position, and the locking arm allows movement of the keeper in the unlocked position.

10. The apparatus of claim 9, further comprising:
a blocking arm rotatably coupled to the housing;
wherein the locking arm is configured to prevent movement of the blocking arm in the locked position and to allow movement of the blocking arm in the unlocked position, and the blocking arm is configured to prevent rotation of the keeper in the locked position.

11. The apparatus of claim 9, further comprising:
a blocking arm rotatably coupled to the housing;
wherein the locking arm is configured to prevent movement of the blocking arm in the locked position;
wherein the blocking arm is configured to prevent rotation of the keeper in the locked position; and
wherein the actuator arm is configured to rotate the locking arm away from the blocking arm to allow the blocking arm to rotate in the unlocked position.

12. The apparatus of claim 9, wherein:
the keeper is rotatable about a hinge; and
the actuator arm is disposed within the housing substantially parallel to the hinge.

13. The apparatus of claim 9, wherein the motor is operable on direct current at twelve volts or less.

14. The apparatus of claim 9, wherein the motor is operable on direct current in a range of about three volts to about six volts.

15. An access control device, comprising:
a keeper;
a motor;
an actuator arm coupled to the motor; and
a locking arm coupled to the actuator arm;
wherein the motor is operable on direct current at twelve volts or less to move the actuator arm from a locked position to an unlocked position, and the locking arm is configured to prevent movement of the keeper in the locked position and to allow movement of the keeper in the unlocked position.

16. The access control device of claim 15, wherein:
the keeper is configured to receive a latch; and
the locking arm prevents rotation of the keeper in the locked position, and the locking arm allows rotation of the keeper in the unlocked position to release the latch.

17. The access control device of claim 16, further comprising:
an access control unit coupled to the motor and configured to determine if access should be allowed; and
wherein if the access control unit determines that access should be allowed, the access control unit delivers power to the motor.

18. The access control device of claim 17, wherein the access control unit is configured to be operated on a direct current source.

19. The access control device of claim 18, wherein the direct current source is a battery having a voltage of nine volts or less.

20. (canceled)
